(19) United States
(12) Patent Application Publication
(10) Pub. No.: US 2010/0170481 A1
(43) Pub. Date: Jul. 8, 2010

(54) Fog carburetor

(76) Inventors: David H. Walker, Winchester, MA (US); Andrew C. Harvey, Waltham, MA (US); Nathan B. Longo, Calais, VT (US)

Correspondence Address: Iandiorio Teska & Coleman, 260 Bear Hill Road, Waltham, MA, 02451, US

(21) Appl. No.: 12/653,337

(22) Filed: Dec. 8, 2009

Related U.S. Application Data
(60) Provisional application No. 61/201,700, filed on Dec. 12, 2008.

(51) Int. Cl. F02M 15/04; F02M 15/00; F02M 31/093; F02M 17/00

(52) U.S. Cl. 123/549; 261/147; 261/145; 261/137; 261/142; 261/131

(57) ABSTRACT

A conversion system for a gasoline engine based generator enables the use of heavier fuels. A vertically disposed vortex separation chamber includes an inlet proximate the bottom of the chamber and tangential to the longitudinal axis of the chamber for delivering to the chamber partially vaporized fuel in an air-fuel mixture from a carburetor associated with the engine. An outlet proximate the top of the chamber also tangential to the longitudinal axis of the chamber for delivering vaporized fuel from the chamber to the engine. An electric heater is in communication with the bottom of the chamber for heating the chamber wall to vaporize any fuel thereon so vaporized fuel is reintroduced in swirling air-fuel mixture in the chamber. A battery source charged by the generator provides power to the electric heater. A jacket is disposed about and spaced from the chamber wall creating an annulus between the jacket and the chamber wall. An inlet through the jacket is connected to receive exhaust gas from the engine and to deliver the exhaust gas into the annulus for heating the chamber.

### RELATED APPLICATIONS

This application hereby claims the benefit of and priority to U.S. Provisional Application Ser. No. 61/201,700, filed on Dec. 12, 2008 under 35 U.S.C. §§119, 120, 363, 365, and 37 C.F.R. §1.55 and §1.78.

### FIELD OF THE INVENTION

The subject invention relates to systems enabling a gasoline engine to operate using heavier fuels.

### BACKGROUND OF THE INVENTION

Military personnel may use portable generators such as a Honda 1000 watt generator during field operations. The Honda generator is configured to burn gasoline. Sometimes, gasoline is not readily available. Running such a gasoline burning engine on heavier fuels like kerosene, diesel fuel, heating oil, jet fuel (JP8), and the like results in power loss, higher emissions, thinning of the engine oil, and/or pre-ignition, commonly known as knocking.

In general, heavier fuels do not work well in spark ignition internal combustion engines because the heavier molecular constituents of the fuel do not vaporize and burn during combustion. The resulting residue of the heavy constituents coats the cylinder walls of the engine and either forms carbon deposits through partial burning or the constituents run down the cylinder walls and mix with the engine lubricating oil. It is also difficult to start an internal combustion engine using heavy fuels. Inadequate vaporization of the fuel occurs when the engine is cold which prevents combustion in the engine even if the mixture is choked to be fuel-rich.

Relevant prior art includes U.S. Pat. No. 1,473,999 and U.S. Pat. No. 5,555,853, both incorporated herein by this reference. The systems described therein, however, either suffer from one or more technical limitations and/or do not meet the needs fulfilled by the subject invention.

### BRIEF SUMMARY OF THE INVENTION

It is an object of this invention to provide a new system for allowing a gasoline engine to operate using heavier fuels. In one example, a new conversion system for a gasoline engine based generator enables the use of heavier fuels with the generator when gasoline is not available.

It is a further object of the invention to provide a new system for vaporizing heavy fuels whereby more complete combustion of the fuels is obtained in the engine. In one aspect, such a system enabling a gasoline engine to operate using heavier fuels is compact, man-portable, and can be cold started using heavy fuels.

The subject invention features, in one example, a system for allowing a gasoline engine to operate using heavier fuels. One preferred system comprises a carburetor including a heavy fuel input and an air input for metering the relative amounts of air and fuel providing an air-fuel mixture with partially vaporized fuel that flows into a vortex separation chamber. A wall defines the chamber having a longitudinal axis. An inlet receives the partially vaporized air-fuel mixture from the carburetor, and an outlet from the chamber is displaced from, and tangential to the longitudinal axis. The outlet is connected to the engine. The chamber is configured to cause a swirling action of the air-fuel mixture in the chamber from the inlet to the outlet urging any non-vaporized fuel to centrifugally migrate outward to the chamber wall forming a fuel film thereon. A heating subsystem is provided for the chamber wall to vaporize the fuel film thereon. The vaporized fuel is then reintroduced into the swirling air-fuel mixture in the chamber.

Typically, the inlet is below the outlet. In one preferred embodiment, the wall defines a cylindrical chamber having a vertical axis. The outlet may comprise a conduit extending into the chamber beyond the wall, thereby preventing any liquid fuel on the chamber wall from exiting the chamber through the outlet.

The heating subsystem typically includes means for directing engine exhaust about the chamber such as a jacket about and spaced from the chamber wall. The jacket includes an exhaust gas inlet and an exhaust gas outlet. In one version, a partition is disposed between the chamber wall and the jacket urging exhaust gas to flow around the chamber wall. Also included may be a valve closed when the exhaust gas flow is at a predetermined lower pressure P_{L} to increase the amount of exhaust gas entering the jacket exhaust gas inlet. The value is automatically opened when the exhaust gas flow is at a predetermined higher pressure P_{H} to decrease the amount of exhaust gas entering the jacket exhaust gas inlet. One valve includes a pivoting member urged closed by a spring having a spring force less than or equal to the force due to P_{H}.

The heating subsystem also typically includes an electric heater powered by a battery. In one example where the gasoline engine drives a generator, the system may further include a charging circuit powered by the generator for charging the battery. The heating subsystem typically also includes a controller configured to control the operation of the electric heater.

In one design, a conversion system for a gasoline engine based generator enables the use of heavier fuels and includes a vertically disposed vortex separation chamber configured to cause a swirling action of the air-fuel mixture in the chamber from an inlet to an outlet urging any non-vaporized fuel to centrifugally migrate outward to the chamber wall forming a fuel film thereon. An electric heater is in communication with the bottom of the chamber for heating the chamber wall to vaporize any fuel thereon so vaporized fuel is reintroduced in swirling air-fuel mixture in the chamber. There is a battery source providing power to the electric heater and charged by the generator. A jacket disposed about and spaced from the chamber creates an annulus between the jacket and the chamber wall. An inlet through the jacket is connected to receive exhaust gas from the engine and to deliver the exhaust gas into the annulus. An outlet from the jacket is for exhaust gas exiting the annulus.

Preferably the vortex separation chamber inlet and outlet are on the same side of the chamber and off-set from the center of the chamber along an axis spaced from the center line of the chamber.

A system for vaporizing heavy fuels in accordance with the invention features a vortex separation chamber defining a longitudinal axis, a jacket about and spaced from the vortex separation chamber defining an annulus between the chamber and the jacket, an air-fuel mixture inlet conduit extending through the jacket and into the vortex separation chamber delivering an air-fuel mixture therein, and an air-fuel mixture outlet conduit extending through the jacket and into the vortex separation chamber delivering the air-fuel mixture in the chamber to an engine. An exhaust inlet conduit extends through the jacket delivering engine exhaust gas into the annulus between the jacket and the vortex separation chamber and an exhaust outlet conduit extends though the jacket for engine exhaust gas exiting the annulus between the jacket and the vortex separation chamber.

Preferably, vortex separation chamber is vertically disposed and both the air-fuel mixture inlet and the air-fuel mixture outlet are tangential to the longitudinal axis of the vortex separation chamber. In one example, an electric heater is associated with the vortex separation chamber.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a highly schematic diagram showing the primary components associated with an example of a system for allowing a gasoline engine driving a generator to operate using heavier fuels;

FIG. 2 is a schematic three-dimensional front view showing the fog carburetor of FIG. 1 mounted to a small engine;

FIG. 3 is a schematic three-dimensional side view showing the vortex separation chamber depicted in FIG. 1;

FIG. 4 is a schematic top view of the system shown in FIG. 2;

FIG. 5 is a cross-sectional side view taken along lines 5-5 of FIG. 4;

FIG. 6 is a schematic three-dimensional view showing an example of the jacket about the vortex separation chamber shown in FIGS. 3-5;

FIG. 7 is a schematic top view of the jacket showing the inlet and outlet;

FIG. 8 is a schematic bottom view of the jacket showing the inlet and outlet;

FIG. 9 is a highly schematic exploded view showing the vortex separation chamber and the jacket separate from each other to illustrate the spiral partition between them;

FIG. 10 is another schematic three-dimensional view showing the jacket depicted in FIGS. 6-9;

FIG. 11 is a schematic diagram of the flow of the exhaust gas depicted in FIG. 1 through the fog carburetor and then out to the atmosphere;

FIG. 12 is a schematic front view showing an example of a pressure controlled bypass valve useful in accordance with the subject invention;

FIG. 13 is a schematic three-dimensional rear view of the valve shown in FIG. 12;

FIG. 14 is a schematic electrical diagram showing the primary components typically associated with the controlling circuitry and the charging circuit depicted in FIG. 1;

FIG. 15 is a schematic three-dimensional side view showing an example of a generator equipped with the system for enabling a gasoline engine to operate using heavier fuels in accordance with the invention;

FIG. 16 is a schematic three-dimensional side view showing a portion of the generator shown in FIG. 15 providing an input/output section for the user;

FIG. 17 is a schematic top view showing another example of a vortex separation chamber with a jacket in accordance with the invention;

FIG. 18 is a schematic side view of the vortex chamber with a jacket shown in FIG. 17;

FIG. 19 is a schematic side view showing another portion of the fog chamber with jacket shown in FIG. 18;

FIG. 20 is a schematic top view of another version of a fog chamber with a jacket in accordance with the invention; and

FIG. 21 is a schematic side view of the fog chamber of FIG. 19.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

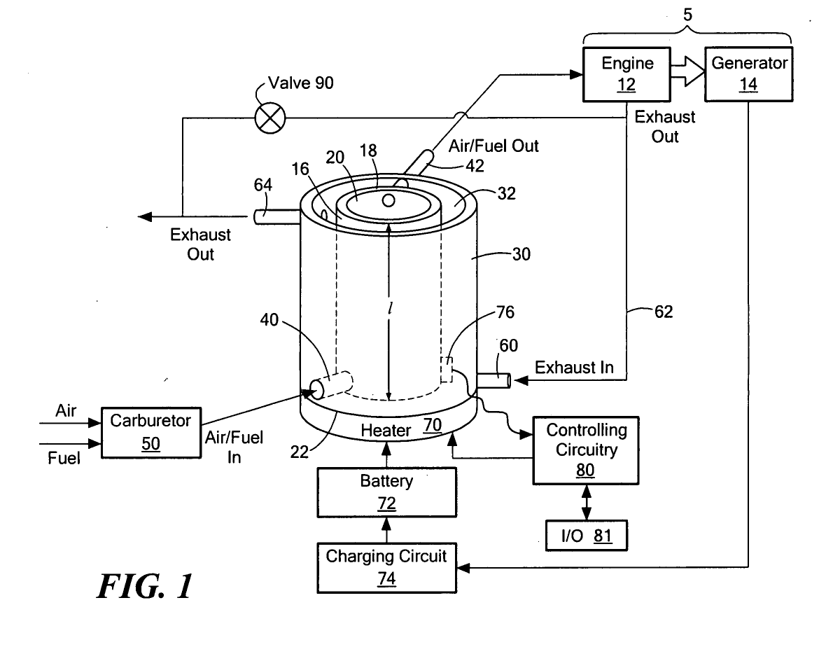

In the subject invention where a unit 5, FIG. 1 such as a Honda 1000 W portable generator includes gasoline powered engine 12 driving generator unit 14 to produce electricity, a conversion system enabling engine 12 to run using heavier fuels such as diesel, kerosene, JP8, and the like includes cylindrical vortex separation chamber 16, typically vertically disposed as shown (with respect to gravity). Wall 18 defines chamber 20 having a longitudinal vertically oriented axis £ between a top cover (not shown) and bottom section 22. Jacket 30 surrounds vortex separation chamber 16 defining an annulus 32 between the exterior of vortex separation chamber 16 and the interior of jacket 30. Jacket 20, chamber 16, and heater 70 define fog generator assembly 6.

This fog generator 6 also includes air-fuel mixture inlet 40 near the bottom of the assembly which extends via a conduit through jacket 30 and wall 18 of vortex separation chamber 16 opening into chamber 20. An air-fuel mixture from carburetor 50 contains partially vaporized heavy fuel delivered via inlet 40 into chamber 40. Typically, carburetor 50 is the carburetor supplied with the generator unit or other suitable model and includes an air input and a fuel input and is configured to meter the relative amounts of air and fuel providing an air-fuel mixture with partially vaporized fuel. Such a carburetor typically includes a float chamber, a choke, a throttle, and the like. Although in FIG. 1 carburetor 50 is shown, the system of the subject invention can be applied to engines using fuel injection for metering of the fuel with the combustion air. A dual air flow carburetor could also be used in which the major air flow does not flow through vortex separation chamber 16.

Air fuel mixture outlet 42 opens into chamber 20 near the top thereof and this conduit extends through wall 18 of vortex separation chamber 16 and jacket 30 delivering the air fuel mixture ultimately to the cylinder or cylinders of engine 12. Jacket 30 and vortex separation chambers 16 may be made of stainless steel.

Chamber 20 is configured to cause a swirling action of the air-fuel mixture in the chamber from inlet 40 to outlet 42 urging any non-vaporized fuel to centrifugally migrate outward to chamber wall 18 forming a fuel film thereon.

To enhance the swirling action of the mixture, both the air-fuel inlet 40 and air-fuel outlet 42 are preferably displaced radially from, and tangential, to the longitudinal l axis of vortex separation chamber 16. This design of the chamber achieves a vortex effect for maximum separation of the fuel from the air. This feature results in the interior of chamber wall 18 being coated with a thin film of fuel which provides effective vaporization of the fuel while limiting the exposure of the combustion air to heating. The temperature rise of the air is thus limited to nearly that needed for condensation of the vaporized fuel which helps maximize the power output of the engine while also minimizing knocking. Inlet 40 is designed to establish a tangential flow of the air-fuel mixture to initiate the vortex swirl and the separation of any non-vaporized fuel. Outlet 42 is designed to prevent migrating liquid fuel film from entering the engine and it is also designed to capture the dynamic pressure of the circumferential air flow established at inlet 40. Outlet 42 is aligned with the flow pattern as discussed below.

Heat is provided to vortex separation chamber 16 typically using two subsystems. First, jacket 30 includes exhaust inlet conduit 60 therethrough delivering engine 12 exhaust gas as shown at 62 into the space 32 between jacket 30 and vortex separation chamber 16. This hot exhaust gas heats wall 18 of vortex separation chamber 16 and then exits via exhaust outlet conduit 64 opening into the space between jacket 30 and vortex separation chamber 16 and extending through the jacket to be connected to the exhaust output of engine 12 as shown. Valve 90 is used in one preferred embodiment to regulate the amount of exhaust gas delivered into the annulus between chamber 18 and jacket 30.

Particularly at startup, electric heater 70 is also provided preferably coupled to bottom wall 22 of the assembly. In one example, heater 70 is a resistance heater with a spiral heating coil element mated to bottom wall 22 by brazing, for example. Battery 72 is provided for powering heater 70. Electrical power provided by generator 14 is conveniently used to charge battery 72 via charging circuit 74.

A temperature sensor such as thermocouple 76 on vortex separation chamber wall 18 (or bottom wall 22) is typically provided to detect the temperature of wall 18 (or wall 22) of vortex separation chamber 16 and provides an output to controlling circuitry 80 which turns heater 70 on and off to maintain a prescribed temperature for vortex separation chamber 16 depending upon the mode of operation. Electric heater 70 is especially useful for cold starting of engine 12 and allows the use of heavy fuel alone for engine operation. A more volatile fuel is not typically required for starting. Controlling circuitry 80 can also be configured to run heater 70 during normal operation of engine 12 to maintain a constant temperature for wall 18 regardless of the flow rate of the air-fuel mixture and/or the engine exhaust or to compensate for a low ambient temperature.

The flow of the engine exhaust gas is regulated by valve 90 to ensure that as much exhaust heat as possible is available during low power operation and also to bypass some of the exhaust gas during higher power operations so that the air-fuel mixture is not over heated.

Thus, wall 18 is preferably heated by a combination of heat exchange with the engine exhaust gas and electric heater 70. Electric heater 70 may be used during normal operation to maintain wall 18 at a constant temperature via controlling circuitry 80 which is configured to cycle heater 70 on and off in response to the temperature measurement output by thermocouple 76. Using input/output section 81, the user can set the temperatures at which electric heater is to be turned on and off. Heating by either heater 70 and/or the exhaust gas as described herein heats the fuel in contact with the inside of wall 18 to vaporize the fuel whereupon the fuel vapor is re-entrained in the spiraling swirling air flow within chamber 20. Condensation of the fuel vapor in the air occurs forming tiny micron-sized droplets, i.e., fog. The mixture of air, fuel vapor, and fog exits chamber 20 at the top as shown through outlet 42 which protrudes into chamber 20 by a small amount. This protrusion of the conduit prevents any liquid fuel on the chamber wall from exiting the chamber via outlet 42. The tangential design of outlet 42 also captures as much of the dynamic pressure of the flow as possible. The resulting mixture is then directed via outlet conduit 42 to the combustion chamber of the engine.

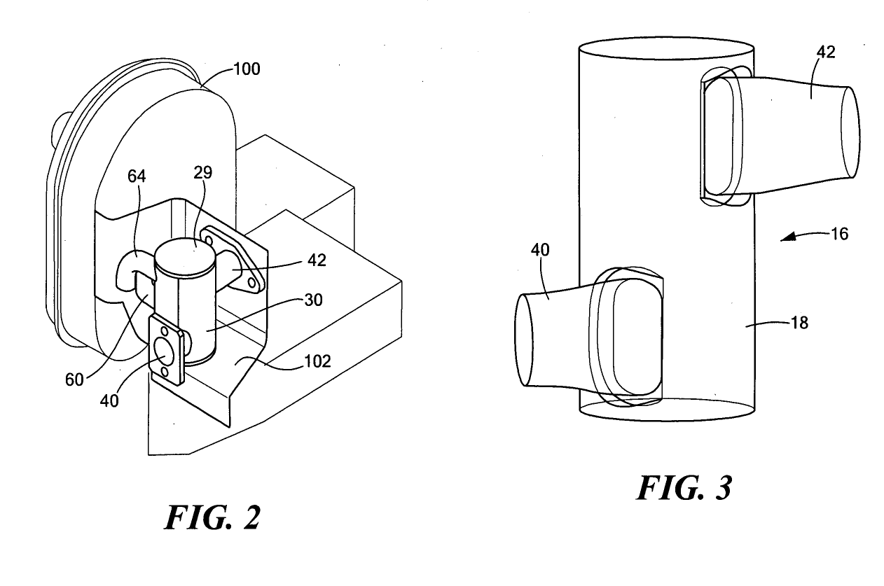

FIG. 2 shows the fog generator 6 with jacket 30 as well as top cover 29, air-fuel mixture inlet conduit 40 (connected to the carburetor (not shown)), air-fuel mixture outlet conduit 42 (connected to the engine combustion chamber (not shown)), exhaust inlet conduit 60, and exhaust outlet conduit 64 near muffler 100. The result is a small, low profile, light weight system easily configured with a portable generator unit near engine bracket 102.

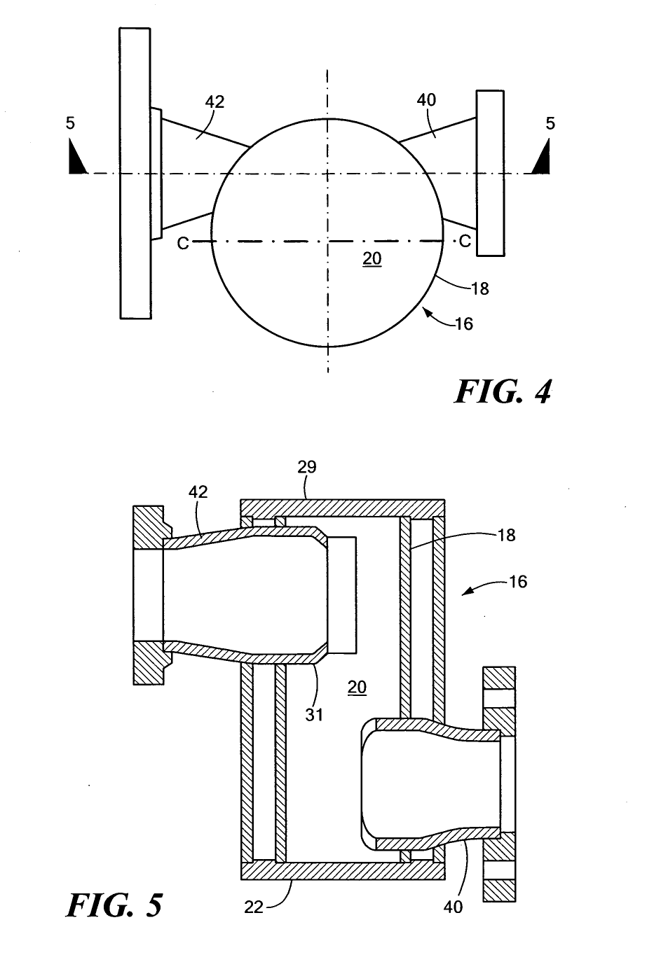

FIG. 3 shows vertically oriented vortex separation chamber 16 as well as inlet 40 and outlet 42. The inlet and outlet piping of the chamber are tangential to the longitudinal axis of chamber 16 and on the same side of chamber 16 (e.g., nearly in the same plane) to better promote a vortex within chamber 16. FIG. 4 shows how inlet 40 and outlet 42, from a top view, are in-line but displaced from the center axis C of chamber 16. This particular arrangement encourages a swirling of the flow while allowing the diameter of the chamber to be as small as possible for a more portable and less obtrusive system. Simulation testing resulted in a strong rotational flow occurring between inlet 40 and outlet 42. FIGS. 4 and 5 also show how the inlet and outlet are in the same plane and also tangential to the desired swirling flow path of the air-fuel mixture. Inlet 40 also directs the flow off axis from centerline C, FIG. 4 to establish a swirling flow. Note too that outlet 42 is also positioned off-axis.

FIG. 5 also shows how air-fuel mixture outlet 42 extends partially into chamber 20 as shown at 31 to prevent any liquid fuel on the interior of wall 18 from exiting out conduit 42. Because conduit 42 is bolted to the engine, it also receives heat from the engine which is beneficial. FIG. 4 also shows how inlet 40 directs the incoming air-fuel mixture to cause the swirling action. As discussed above, the vertical nature of the chamber 20 results in any non-vaporized fuel, during starting, for example, in dropping down the chamber wall to be heated by heater 70, FIG. 1.

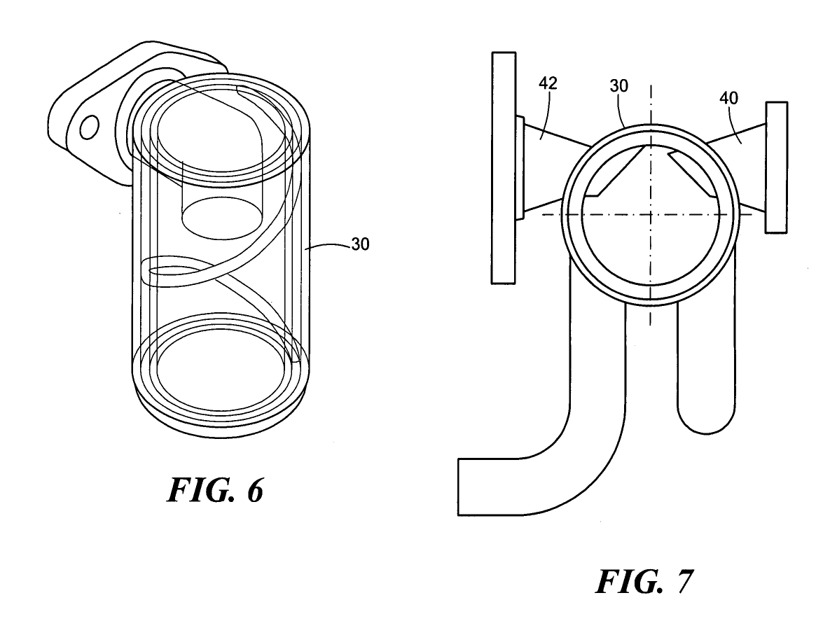

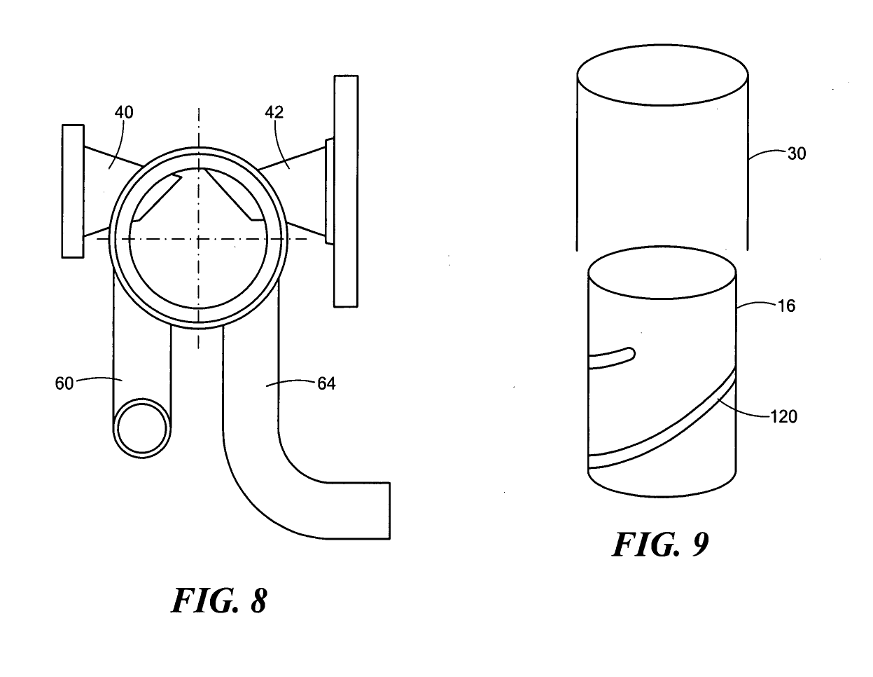

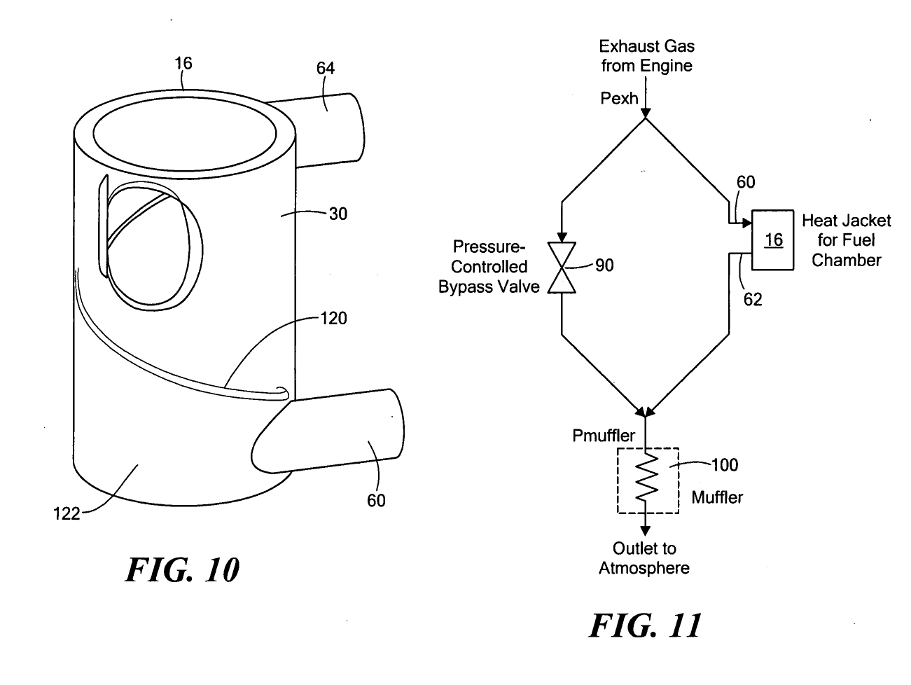

FIGS. 6-8 show in more detail outer jacket 30 used to constrain the exhaust gas flow around the vortex separation chamber. A spiral partition 120, FIG. 9 was installed in the annulus between vortex separation chamber 16 and jacket 30 to cause the exhaust gas to flow around vortex separation chamber 16. FIG. 10 depicts the flow of exhaust gas at 122 in the annulus between the vortex separation chamber 16 and jacket 30 from exhaust gas inlet 60 to exhaust gas outlet 64.

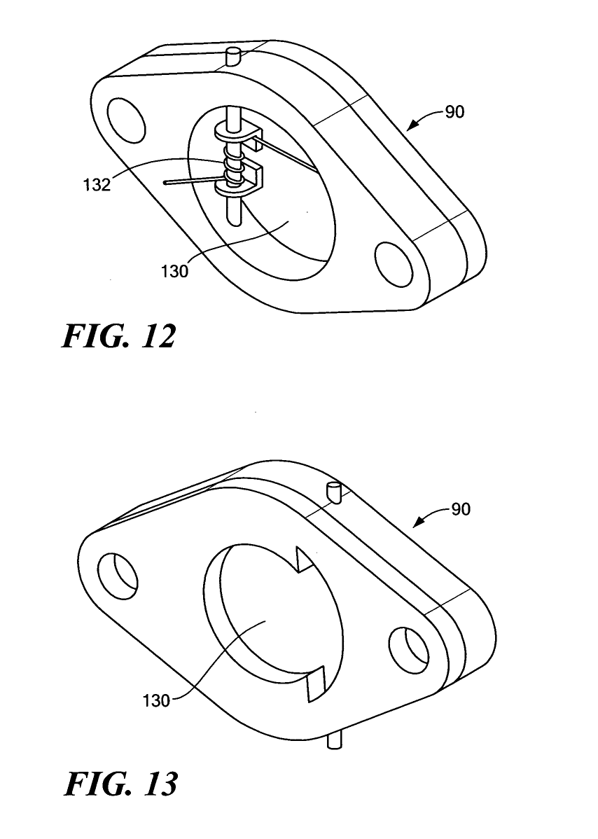

FIG. 11 shows muffler 100 and how exhaust gas from the engine is divided to provide heat for the vortex separation chamber subsystem depicted at 16 (see exhaust inlet conduit 60 and exhaust outlet conduit 64, FIG. 2) and also to valve 90 before being rejoined at muffler 100. Valve 90, disposed in the engine exhaust stream, is preferably configured to be closed when the exhaust gas flow from the engine is at a predetermined lower pressure P_{L} but open when the exhaust gas flow is at a higher predetermined pressure P_{H}. When the generator is experiencing low loads, the exhaust flow is minimal and thus valve 90 is closed to direct all of the exhaust from the engine to the annulus between the vortex separation chamber and the jacket via inlet 60 as shown in FIG. 11. At higher generator electric loads, the flow of all the exhaust gas to this annulus could result in overheating. Thus, at higher generator electric loads, valve 90 is automatically opened.

In one example, valve 90 includes pivoting flow restriction member 130, FIGS. 12 and 13 urged closed by spring 132, FIG. 12. Spring 130 is chosen to have a spring force less than or equal to the force due to the exhaust gas flow at a predetermined higher pressure P_{H} typically when the generator is operating to produce higher electric loads. At these higher loads, the exhaust gas pressure created at the valve inlet is great enough to overcome the spring force and open flapper 130. This prevents the air-fuel mixture from getting too hot and causing knocking in the engine.

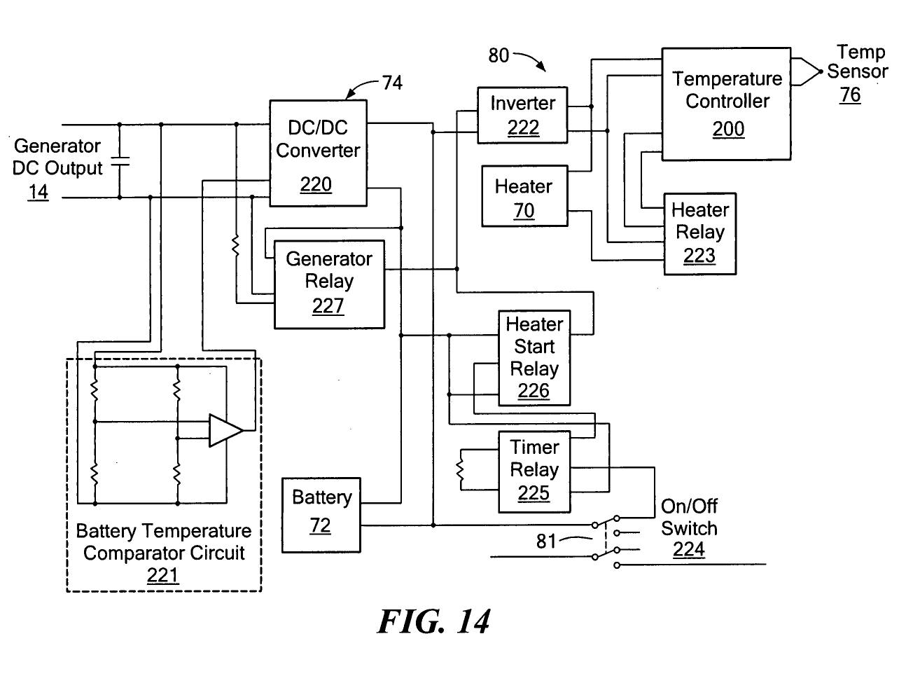

FIG. 14 shows several of the components associated with charging circuit 74, FIG. 1 and controlling circuitry 80, also shown in FIG. 1. Generator 14 provides power as shown to charging circuit 74. Battery 72, and heater 70 are also shown, as is input/output section 81. Temperature controller 200 is connected to thermocouple 76.

In one version, electrical power for the heater 70 is provided by a set of nickel-metal hydride batteries 72 that are recharged during generator operation. Power for battery charging is taken from the AC output of the generator through a battery charging circuit 74 configured to monitor the current draw and the temperature of the batteries in order to control the charging rate. The charger is turned on when the generator is on and the heater is off. When the heater is turned on, charging of the battery is turned off. In order to start the generator, the heater must be turned on prior to starting. An on-off switch for the generator set triggers the heater circuit and a timer relay. The heater circuit continues to heat the chamber unless the timer relay times out, indicating that no attempt to start the engine was made. Once the engine is started, the heater functions based upon controller 200 and temperature sensor 76 located on the fog chamber surface at the heater.

Power for the battery charging is taken from the 12 VDC output of the generator as shown at 14. The DC power is first passed through DC/DC converter 220 where the voltage is increased to 15 VDC. Power flow to the battery is controlled by battery temperature comparator circuit 221 that cuts the power flow when the battery temperature rises above 55° C. The battery is allowed to cool to below this temperature prior to the power being switched on, restarting the charging of the battery.

FIG. 14 also shows the circuitry associated with the fuel chamber heater. The DC power from the battery is converted to 120 VAC at inverter 222 for operation of heater 70 and temperature controller 200. The temperature controller regulates the heated based upon comparison of the fuel chamber temperature and a set point. When the temperature is below the set point, the controller activates the heater relay 223 that directs AC power to the heater coil. Once the temperature of the chamber is at or exceeds the set point value, the controller deactivates the heater relay to shut off current to the heater.

The starting point of the engine occurs when the on/off switch 224 is placed in the on position which starts the flow of current from the battery to the inverter and also triggers time relay 225 which initiates heater start relay 226 through which the current to the inverter is routed during starting. The timer relay times out after 5 minutes if the engine is not started which deactivates the heater start relay shutting off current flow to the inverter, heater, and temperature controller. If the engine is started, generator relay 227 is activated by sensing the DC output of the generator. The contacts on the generator relay are placed in parallel with those of the heater start relay such that the current to the inverter passes through them once the engine is started. If the on/of switch is later turned to the off position, the engine operation is stopped terminating the DC output of the generator which deactivates the generator relay stopping the flow of current to the inverter, heater, and temperature controller.

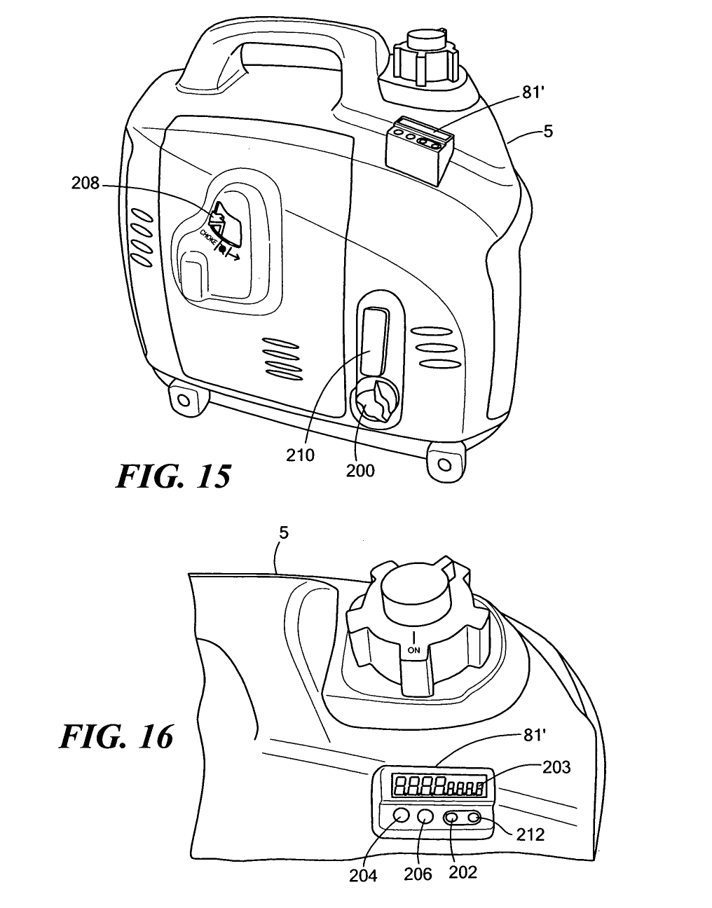

FIG. 15 shows an example of a generator unit 5 equipped with a system allowing the gasoline engine of generator unit 5 to operate using heavier fuels as discussed above. Input/output section 81, FIG. 1, in this example, is in the form of temperature controller interface 81′ shown in more detail in FIG. 16. FIG. 15 further depicts how the overall profile of generator unit 5 is not changed substantially even with the addition of the components depicted in FIG. 1. For operation, on/off switch 200 is first switched to the on position. A light associated with temperature controller interface 81′, FIG. 16 will then turn on indicating that the unit is then ready for operation and that the vortex separation chamber is being heated by the electric heater powered by the batteries. Once the heater is turned on, the temperature set point is set to 400° F. using button 202. Display 203 enables the user to view when the correct temperature set point is reached. The set point is changed by pressing buttons 204 and 206. Button 204 lowers the temperature, while button 206 raises the temperature. The temperature in the vortex separation chamber will rise to 400 degrees in approximately 2 to 3 minutes. Once this temperature is reached, a small red light on temperature controller interface 81′ begins to the blink indicating the heater is turning on and off. The engine is now ready to start. Choke lever 208, FIG. 15 is moved so that the choke is closed and the engine can now be started by pulling starter cord 210. Typically cord 210 will have to be pulled 3 to 5 times to allow adequate fuel to enter the fuel vaporizing system. At that point, the engine should start running. Choke 208 is then adjusted until smooth, continuous operation of the engine is achieved. The engine should be run for several minutes until it has warmed up enough so that the choke can be opened fully and the engine runs smoothly. Once the engine is warm, the heater set point should be lowered to 320° F. using set point lower button 212, FIG. 16.

Laboratory testing was conducted with a test gasoline-fueled engine that was converted for use with the fog carburetion process described herein. Testing was conducted with kerosene. The testing indicated that no power loss was experienced and the fuel efficiency of the engine was roughly the same with either gasoline or kerosene at 0.9 lb/kW-hr. Cold starting of the engine with kerosene only was demonstrated to an ambient temperature of approximately 0° F. Engine knocking did occur on a limited basis. In order to reduce knocking further, the compression ratio of the engine was reduced slightly from 8:1 to 7:1.

In order to show that no lubrication oil thinning occurred with the use of fog carburetion, an engine endurance test was conducted. FIGS. 15-16 show the converted Honda generator set used for this test, which included commercial engine rated at 1.32 kW. The engine was operated for 400 hours using kerosene as the fuel with fog carburetion. Testing was performed on the basis of 8-hour days in which the engine was cold-started on kerosene each morning and was later shut down at night. The engine oil was changed at 100-hr intervals as recommended by the engine manufacturer. Samples from the drained engine oil were kept for analysis. For comparison, an un-modified second 1-kW generator set was run for 100 hours by simply filling the fuel tank with kerosene and starting the engine with propane. Oil samples were removed from the no-fog, kerosene-fueled engine at 50 and 100 hours. A third generator set was run for 100 hours on gasoline and was used after engine teardown for wear comparison with the fog-carbureted and no-fog kerosene units.

The unit employing fog carburetion showed no change in oil viscosity for all samples taken and the fuel content of the oil was less than 2%, which is the lowest increment given by the oil test laboratory. In comparison, the oil sample from the unit with no fog carburetion showed, after 50 hours of operation, a decrease in oil viscosity to 1.99 centistokes and a fuel dilution of 11.4%. Comparison of total alkalinity between the two samples also indicated that acid formation had begun in the no-fog oil sample.

The resulting heavy fuel, man-portable generator is capable of delivering 900 W of power continuously at 120 VAC and has a peak power capability of 1,000 W for a period of 20 minutes. The unit has a fuel tank that holds 0.6 gal. The operating duration for the generator when delivering 900 Watts of power is 4 hours. The dry weight of the generator is 33 lb., including the fog carburetor components, heater, battery charger, and batteries. The noise rating of the generator is 59 dB at a distance of 3 meters.

The preferred fog carburetion system includes several novel features including the design of the chamber to achieve a vortex effect for maximum separation of the fuel from the air. This feature coats the chamber wall with fuel which provides effective vaporization of the fuel while limiting the exposure of the combustion air to heating. The temperature rise of the air is limited nearly to that resulting from condensation of the vapor to fog droplets, which helps maximize the power output of the engine while also minimizing the tendency for uncontrolled combustion of the fuel. Part of the unique design of the chamber includes the inlet and outlet configurations. The inlet is designed to encourage tangential flow of the air-fuel mixture to initiate the vortex swirl and the separation of the non-vaporized fuel. The outlet is designed to prevent liquid fuel from entering the engine. The vortex chamber is also preferably equipped with an electric heater for cold start of the engine which allows the use of heavy fuel for starting as well as engine operation. The heater may also be run during normal operation to maintain constant wall temperature regardless of the flow rate of the air-fuel mixture or the engine exhaust. The flow of engine exhaust gas is preferably regulated by a pressure controlled bypass damper valve that insures as much exhaust heat as possible is available during low power operation and also bypasses some of the exhaust gas during high power operation so that the air-fuel mixture is not overheated. The fog carburetion system can be applied to engines using either a carburetor or fuel injection for the metering of fuel with combustion air.

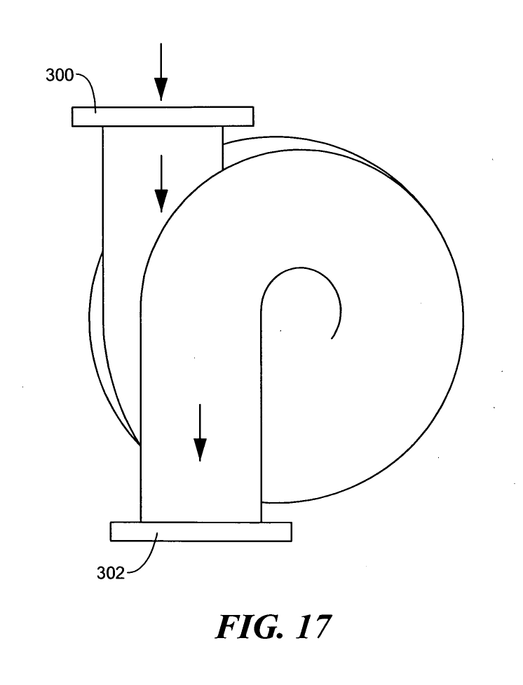

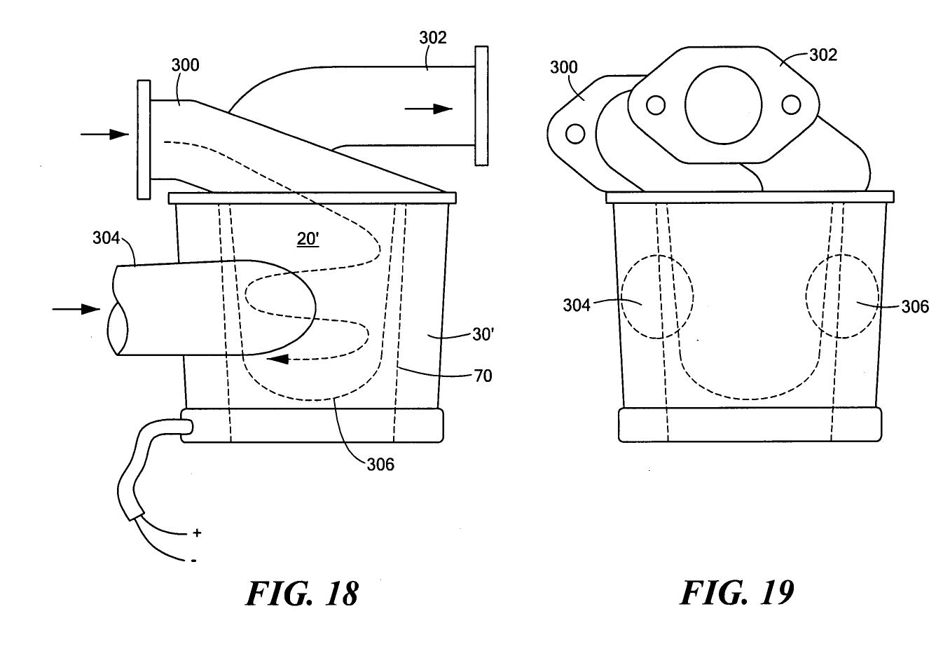

FIGS. 17-19 show another design for the fog carburetor where the air-fuel inlet is via conduit 300, the air-fuel outlet is via conduit 302, the exhaust inlet is via conduit 304, and the exhaust outlet is shown at 306. In this design, chamber 20′ has a concave bowel shape as shown at 306 at the bottom of chamber 20′. Here, the air-fuel mixture inlet 300 and outlet 302 are at the top of chamber 20′. As shown in FIGS. 17-19, both the mixture inlet and outlet are above the actively heated zones so that the chamber volume in which fog is generated can be minimized, and also the construction of the fogging unit can be simplified. With the position of the mixture inlet above the heated zones, the mixture flow can be directed to angle downward as well as tangential to the inner wall of the swirl chamber in order to centrifugally direct the fuel drops around and down the chamber surface, which may optimally have the rounded bowl bottom shape shown. In the vortex, the flow near the wall loses momentum due to friction with the wall, and the lower momentum flow migrates to the core of the vortex where it is displaced upward to the exit, carrying fog and vapor in the air.

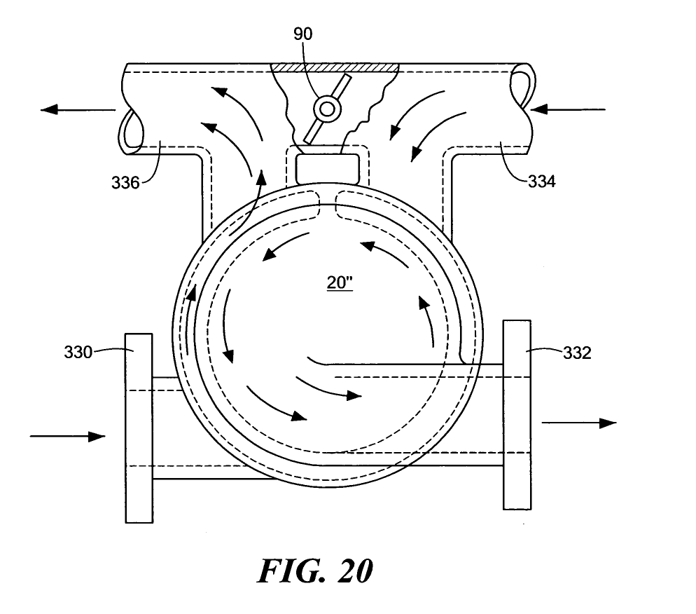

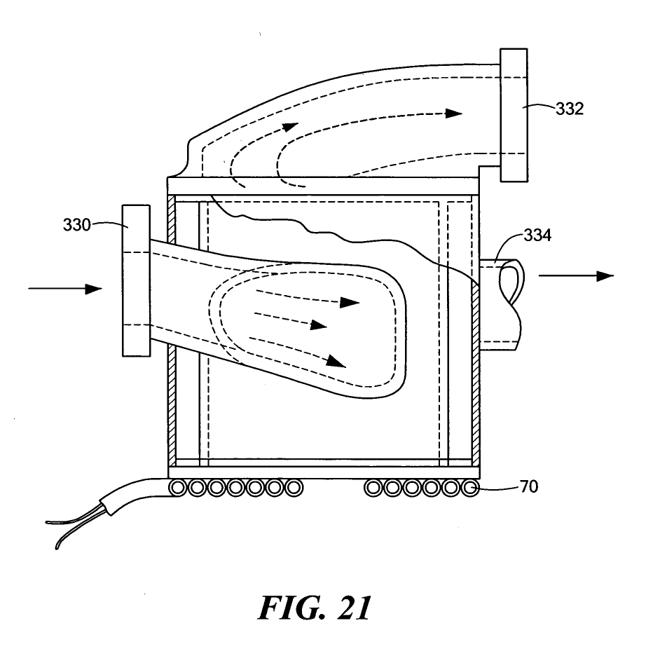

The design of FIGS. 20-21 is also possible. Here the air-fuel mixture inlet is shown at 330, the air-fuel outlet is shown at 332, the exhaust gas inlet is shown at 334, and the exhaust gas outlet is shown at 336. In order to minimize the heat added to the fuel-air mixture before it enters the engine cylinder, as well as to minimize the size of the fog generator assembly, exhaust heat can be applied or concentrated only on the wall of the swirl chamber where it is wet by liquid fuel. Beyond this wet region it is only desirable to maintain the conduit walls above the condensation temperature or ‘dew point’ of the mixture. The Figures show one preferred design for limiting the heated region while still separating electric and exhaust heat inputs, still preventing liquid exiting the chamber, and still capturing much of the dynamic pressure of the swirling flow. In this design, which also has a vertical axis, only the mixture conduit 330 entering the fog chamber 20″ crosses the engine exhaust flow annulus 32″, so circumferential flow of exhaust gas is not much impeded. This makes it advantageous and practical to provide radial plane fins on the outer wall of the mixture swirl chamber, thereby optimizing exhaust heat transfer while minimizing the area for mixture evaporation, where heat transfer is naturally intense. The vertical position of the mixture inlet 330 on the cylindrical wall of the swirl chamber, and the axial length of this wall, can be optimized.

Control of the heat to, and the temperature of, the vortex chamber and the mixture temperature can be controlled many ways. One way is to provide a bypass valve 90′, FIG. 20 that shunts the hot exhaust directly to the duct leading to the atmosphere instead of forcing the flow through the annulus surrounding the fog chamber. Such a valve can be mounted in close proximity to the fog chamber body. There, the temperature of this body could act on the bypass valve, such as through a bimetallic spring, to regulate the temperature of the fog chamber. This valve could also be designed as a pressure relief valve, or to be servo-controlled by a small electric motor in response to a temperature sensing device. Other options and designs would depend on the application and the particular engine configuration.

Therefore, although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. For example, the subject invention is not limited to use with generator units and can be used with other gasoline powered engines, such as in vehicles.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A system for allowing a gasoline engine to operate using heavier fuels, the system comprising:
a carburetor including a heavy fuel input and an air input for metering the relative amounts of air and fuel providing an air-fuel mixture with partially vaporized fuel;
a vertically disposed vortex separation chamber including:
a wall defining a chamber having a longitudinal axis,
an inlet to the chamber tangential to the longitudinal axis receiving the partially vaporized air-fuel mixture from the carburetor,
an outlet from the chamber also tangential to the longitudinal axis, the outlet connected to the engine,
the chamber configured to cause a swirling action of the air-fuel mixture in the chamber from the inlet to the outlet urging any non-vaporized fuel to centrifugally migrate outward to the chamber wall forming a fuel film thereon; and
a heating subsystem for the chamber wall to vaporize the fuel film thereon, the vaporized fuel reintroduced into the swirling air-fuel mixture in the chamber.

2. The system of claim 1 in which the inlet is below the outlet.

3. The system of claim 1 in which the wall defines a cylindrical chamber.

4. The system of claim 1 in which the outlet comprises a conduit extending into the chamber beyond the wall preventing any liquid fuel on the chamber wall from exiting the chamber through the outlet.

5. The system of claim 1 in which the heating subsystem includes means for directing engine exhaust about the chamber.

6. The system of claim 5 in which the means for directing includes a jacket about and spaced from the chamber wall, the jacket including an exhaust gas inlet and an exhaust gas outlet.

7. The system of claim 6 further including a partition between the chamber wall and the jacket urging exhaust gas to flow around the chamber wall.

8. The system of claim 6 further including a valve closed when the exhaust gas flow is at a predetermined lower pressure P_{L} to increase the amount of exhaust gas entering the jacket exhaust gas inlet, the valve opened when the exhaust gas flow is at a predetermined higher pressure P_{H} to decrease the amount of exhaust gas entering the jacket exhaust gas inlet.

9. The system of claim 8 in which the valve includes a flow restriction member urged closed by a spring having a spring force less than or equal to the force due to P_{H}.

10. The system of claim 1 in which the heating subsystem includes an electric heater powered by a battery.

11. The system of claim 10 in which the gasoline engine drives a generator and which the system further includes a charging circuit powered by the generator for charging the battery.

12. The system of claim 10 in which the heating subsystem further includes a controller configured to control the operation of the electric heater.

13. A system for allowing a gasoline engine to operate using heavier fuels, the system comprising:
a carburetor including a heavy fuel input and an air input for metering the relative amount of air and fuel providing an air-fuel mixture with partially vaporized fuel;
vortex separation chamber including:
a wall defining a chamber,
an inlet to the chamber receiving a partially vaporized air-fuel mixture from the carburetor,
an outlet from the chamber connected to the engine,
the chamber configured to cause a swirling action of the air-fuel mixture in the chamber from the inlet to the outlet urging any non-vaporized fuel to centrifugally migrate outward to the chamber wall forming a fuel film thereon;
an electrical heater associated with the chamber to vaporize the fuel film on the chamber wall, the vaporized fuel reintroduced into the swirling air-fuel mixture in the chamber; and
means for directing engine exhaust about the chamber.

14. The system of claim 13 in which the chamber includes a longitudinal axis and the inlet and outlet are disposed tangential to the longitudinal axis.

15. The system of claim 13 in which the inlet is below the outlet.

16. The system of claim 13 in which the wall defines a cylindrical chamber.

17. The system of claim 13 in which the outlet comprises a conduit extending into the chamber beyond the wall preventing any liquid fuel on the chamber wall from exiting the chamber through the outlet.

18. The system of claim 13 in which the chamber is vertically disposed.

19. The system of claim 13 in which the means for directing includes a jacket about and spaced from the chamber wall, the jacket including an exhaust gas inlet and an exhaust gas outlet.

20. The system of claim 19 further including a partition between the chamber wall and the jacket urging exhaust gas to flow around the chamber wall.

21. The system of claim 19 further including a valve closed when the exhaust gas flow is at a predetermined lower pressure P_{L} to increase the amount of exhaust gas entering the jacket exhaust gas inlet, the valve opened when the exhaust gas flow is at a predetermined higher pressure P_{H} to decrease the amount of exhaust gas entering the jacket exhaust gas inlet.

22. The system of claim 21 in which the valve includes a flow restricting member urged closed by a spring having a spring force less than or equal to the force due to P_{H}.

23. The system of claim 13 in which the electrical heater is powered by a battery.

24. The system of claim 23 in which the gasoline engine drives a generator and which the system further includes a charging circuit powered by the generator for charging the battery.

25. The system of claim 24 in which the heating subsystem further includes a controller configured to control the operation of the electric heater.

26. A conversion system for a gasoline engine based generator enabling the use of heavier fuels, the system comprising:
a vertically disposed vortex separation chamber including:
a wall defining a chamber having a longitudinal axis between a top and a bottom,
an inlet tangential to the longitudinal axis and delivering to the chamber partially vaporized fuel in an air-fuel mixture from a carburetor associated with the engine,
an outlet proximate the top of the chamber, the outlet also tangential to the longitudinal axis for delivering vaporized fuel from the chamber to the engine, and
the chamber configured to cause a swirling action of the air-fuel mixture in the chamber from the inlet to the outlet urging any non-vaporized fuel to centrifugally migrate outward to the chamber wall forming a fuel film thereon;
an electric heater in communication with the bottom of the chamber for heating the chamber wall to vaporize any fuel thereon so vaporized fuel is reintroduced in the swirling air-fuel mixture in the chamber;
a battery source providing power to the electric heater and charged by the generator;
a jacket about and spaced from the chamber wall creating an annulus between the jacket and the chamber wall;
an inlet through the jacket connected to receive exhaust gas from the engine and to deliver the exhaust gas into the annulus; and
an outlet from the jacket for exhaust gas exiting the annulus.

27. The conversion system of claim 26 in which the vortex separation inlet and outlet are on the same side of the chamber.

28. The conversion system of claim 27 in which the vortex separation chamber inlet and outlet are offset from the center line of the chamber.

29. The conversion system of claim 26 in which the chamber outlet comprises a conduit extending into the chamber beyond the wall, thereby preventing a liquid fuel on the chamber wall from exiting the chamber through the outlet.

30. The conversion system of claim 26 further including a spiral member in the annulus between the jacket and the chamber urging the exhaust gas to flow around the chamber wall.

31. The conversion system of claim 26 further including a valve disposed in the engine exhaust stream, the valve closed when the exhaust gas flow is at a predetermined lower pressure P_{L}, thereby increasing the amount of exhaust gas delivered to the jacket inlet; the valve opened when the exhaust gas flow is at a predetermined higher pressure P_{H}, thereby decreasing the amount of exhaust gas delivered to the jacket inlet.

32. The conversion system of claim 31 in which the valve includes a flow restriction member urged closed by a spring having a spring force less than or equal to the force due to P_{H}.

33. The conversion system of claim 26 further including a charging circuit between the generator and the battery.

34. The conversion system of claim 26 further including a temperature sensor associated with the vortex separation chamber for detecting the temperature of the chamber and controlling circuitry responsive to the temperature sensor and configured to control the electric heater based on the temperature of the chamber.

35. A system for vaporizing heavy fuels, the system comprising:
a vortex separation chamber defining a longitudinal axis;
a jacket about and spaced from the vortex separation chamber defining an annulus between the chamber and the jacket;
an air-fuel mixture inlet conduit extending through the jacket and into the vortex separation chamber delivering an air-fuel mixture therein;
an air-fuel mixture outlet conduit extending through the jacket and into the vortex separation chamber delivering the air-fuel mixture in the chamber to an engine;
an exhaust inlet conduit through the jacket delivering engine exhaust gas into the annulus between the jacket and the vortex separation chamber; and
an exhaust outlet conduit through the jacket for engine exhaust gas exiting the annulus between the jacket and the vortex separation chamber.

36. The system of claim 35 in which the vortex separation chamber is vertically disposed and both the air-fuel mixture inlet and the air-fuel mixture outlet are tangential to the longitudinal axis of the vortex separation chamber.

37. The system of claim 36 in which the vortex separation chamber air-fuel mixture inlet and outlet are on the same side of the chamber.

38. The system of claim 37 in which the vortex separation chamber air-fuel mixture inlet and outlet are in-line along an axis offset from a center axis of the chamber.

39. The system of claim 35 further including an electric heater associated with the vortex separation chamber.

40. The system of claim 35 further including a spiral member in the annulus between the jacket and the vortex separation chamber.
